(19) United States
(12) Patent Application Publication
(10) Pub. No.: US 2018/0208780 A1
(43) Pub. Date: Jul. 26, 2018

(54) SENSITIVE LUMINESCENT COMPOSITION

(71) Applicant: DONGWOO FINE-CHEM CO., LTD., Iksan-si (KR)

(72) Inventors: Geo San LIM, Seoul (KR); Kwan Wook SONG, Pyeongtaek-si (KR)

(73) Assignee: DONGWOO FINE-CHEM CO., LTD., Iksan-si (KR)

(21) Appl. No.: 15/880,973

(22) Filed: Jan. 26, 2018

(30) Foreign Application Priority Data
Jan. 26, 2017 (KR) 10-2017-0012390
Jan. 26, 2017 (KR) 10-2017-0012391

(51) Int. Cl. C09D 5/22; C09K 11/02; C09K 11/06; C09D 133/14; C09D 135/02; C09J 7/38

(52) U.S. Cl. CPC C09D 5/22; C09K 11/025; C09K 11/06; C08K 5/3437; C09D 135/02; C09J 7/385; C09D 133/14

(57) ABSTRACT

The present invention relates to a sensitive luminescent composition, which includes a sensitive luminescent material having a maximum absorption wavelength of 450 to 700 nm to improve the beam visibility of a laser pointer.

### CROSS-REFERENCE TO RELATED PATENT APPLICATION

This U.S. non-provisional patent application claims priority under 35 U.S.C. § 119 to Korean Patent Application Nos. 10-2017-0012390 filed on Jan. 26, 2017 and 10-2017-0012391 filed on Jan. 26, 2017 in the Korean Patent Office, the entire contents of which are hereby incorporated by reference.

### FIELD OF INVENTION

The present invention relates to a sensitive luminescent composition.

### BACKGROUND

In meetings or conferences, for enhancing the understanding of listeners, a method of displaying presentation materials using an image display is generally used. In addition, to further enhance the understanding of the listeners, presenters often use a laser pointer to point out a part of the data displayed on the image display to be emphasized.

However, when presentation materials are directly displayed on an image display, since the image display is self-luminous, the visibility of a laser beam emitted from a laser pointer is degraded. In addition, to improve the display quality of the image display itself, reflection-preventing technology for inhibiting the reflection from an image display surface has been developed, and in this case, since the reflection of light emitted from a laser pointer is also inhibited, the beam visibility of a laser pointer is further degraded. Recently, as technology of utilizing a laser pointer as a pointing device for controlling screen operation on the image display has been developed, it is necessary to develop technology for improving the beam visibility of a laser pointer on an image display.

In this regard, in Korean Unexamined Patent Application Publication No. 2014-0026287, a pointing display device, which includes a UV-reactive unit including an UV-reactive material layer containing an UV-reactive material and a base coated with the layer and a UV light source which can irradiate a laser is disclosed, however, in this case, there is a problem of low practicality because of the need for an image display including an UV-reactive material layer and a pointing display including an UV light source which can irradiate an UV laser.

Further, in Korean Patent No. 1107532, a method for improving the beam visibility of a laser pointer by increasing the surface scattering of a laser pointer by taking advantage of the relationship between a haze value and the roughness of a visible surface of a film by including a visible resin layer having a specific haze value and an arithmetic mean surface roughness is disclosed, however, in the case of using such a method using scattering caused by surface roughness, it is difficult to manufacture a clear film.

### PRIOR ART DOCUMENTS

### Patent Documents

Korean Unexamined Patent Application Publication No. 2014-0026287 (Mar. 5, 2014)

Korean Patent No. 1107532 (Jan. 12, 2012)

### SUMMARY OF THE INVENTION

### Technical Problem

The present invention is directed to providing a sensitive luminescent composition which can be used to manufacture an image display which enhances the beam visibility of a laser pointer.

### Solution to Problem

To achieve the above-mentioned objective, a sensitive luminescent composition of the present invention includes a sensitive luminescent material having a maximum absorption wavelength of 450 to 700 nm.

In addition, a hard coating layer of the present invention includes a cured product of the above-mentioned sensitive luminescent composition.

Moreover, an image display of the present invention includes the above-mentioned hard coating layer.

### Advantageous Effects

A sensitive luminescent composition of the present invention includes the above-mentioned sensitive luminescent material, and therefore the beam visibility of a laser pointer is improved.

In addition, a hard coating layer, a photocurable adhesive layer, a heat-curable adhesive layer and a pressure-sensitive adhesive layer of the present invention include a cured product of the above-mentioned sensitive luminescent composition, and a base layer of the present invention includes the above-mentioned sensitive luminescent composition, and therefore the beam visibility of a laser pointer is improved.

In addition, an image display of the present invention includes one or more selected from the group consisting of the hard coating layer, the photocurable adhesive layer, the heat-curable adhesive layer, the pressure-sensitive adhesive layer and the base layer, which have been mentioned above, and therefore the beam visibility of a laser pointer is improved.

### DETAILED DESCRIPTION OF THE INVENTION

In the present invention, when one member is disposed “on” another member, it means that one member may be disposed in contact with the other member, or a third member may be interposed between these members.

In the present invention, when a part “includes”, “comprise” a certain component, it means that, unless particularly defined otherwise, other components are not excluded but may be further included.

Hereinafter, the present invention will be described in further detail.

<Sensitive Luminescent Composition>

Sensitive Luminescent Material

A sensitive luminescent composition according to an aspect of the present invention includes a sensitive luminescent material having a maximum absorption wavelength of 450 to 700 nm, and therefore the beam visibility of a laser pointer emitting light with a wavelength in a range of 450 to 700 nm may be improved using the composition. The “sensitive luminescent material” refers to a material that absorbs light with a specific wavelength and emits light, and the sensitive luminescent composition of the present invention may include a sensitive luminescent material having a suitable range of the maximum absorption wavelength according to the wavelength range of a laser pointer used.

According to an exemplary embodiment of the present invention, the sensitive luminescent material may have a maximum absorption wavelength of 450 to 600 nm. As described above, when the sensitive luminescent composition of the present invention includes a sensitive luminescent material having the maximum absorption wavelength of 450 to 600 nm, the material absorbs a wavelength of a laser pointer emitting light in a wavelength range of 450 to 600 nm (e.g., a green laser pointer uses light with a wavelength of 532 nm, and a yellow laser pointer uses light with a wavelength of 589 nm) and reemits light, and therefore the beam visibility of a laser pointer is further improved.

The sensitive luminescent material having the maximum absorption wavelength of 450 to 600 nm may be any material that satisfies the maximum absorption wavelength range without limitation. Examples of the sensitive luminescent materials may include, but are not limited to, perylene-based derivative dyes such as Lumogen F Yellow 083, Lumogen F Yellow 170, Lumogen F Orange 240, Lumogen F Pink 285, Lumogen F Red 305, Lumogen F Green 850, etc., 7-amino actinomycin D, acridine orange, alamar blue, Alexa Fluor 488, Alexa Fluor 514, Alexa Fluor 532, Alexa Fluor 546, Alexa Fluor 555, Alexa Fluor 568, Alexa Fluor 594, Amplex Red, Amplex Ultra Red, Bodipy 500, Bodipy 510, Bodipy 581, Bodipy 591, Bodipy FL, Bodipy TAN/IRA, Bodipy TMR, Bodipy TR, Cy2, Chromeo 488, DyLight 488, FAM, Chromeo 505, HiLyte Fluor 488, HEX, HiLyte Fluor 555, 5-TAMRA, DyLight 549, phycoerythrin, tetramethyl rhodamine isothiocyanate, Cy3.5f, rhodamine red-X, PE-Dyomics 590, ROX, Lumogen F Red 613, PE-Texas Red, Quantum Red, etc.

Taking into account that the wavelengths of a green laser pointer and a yellow laser pointer, which are conventionally and frequently used, are 532 nm and 589 nm, respectively, the maximum absorption wavelength of the sensitive luminescent material is preferably in a range of 500 to 600 nm.

According to an exemplary embodiment of the present invention, the sensitive luminescent material may have a maximum absorption wavelength of 600 to 700 nm. As described above, when the reactive photosensitive composition of the present invention includes a sensitive luminescent material having the maximum absorption wavelength of 600 to 700 nm, the material absorbs a wavelength of a laser pointer (for example, a red laser pointer uses light with a wavelength at 635 nm) emitting light with a wavelength in a range of 600 to 700 nm and then reemits light, therefore the beam visibility of a laser pointer may be further improved.

The sensitive luminescent material having the maximum absorption wavelength of 600 to 700 nm may be any material that satisfies the above range without limitation. Examples of the sensitive luminescent materials may include, but are not limited to, Alexa Fluor 594, Alexa Fluor 610, Alexa Fluor 633, Alexa Fluor 635, Alexa Fluor 647, Alexa Fluor 660, Alexa Fluor 680, SureLight-APC, DyLight 633, allophycocyanin, Chromeo 642, SureLight-P3, Cy5, DyLight 649, HiLyte Fluor 647, IR Dye 700DX, APC-Cy5.5, HiLyte Fluor 680, DyLight 680, APC-Cy7, etc.

Taking into account that the wavelength of a red laser pointer, which is conventionally and frequently used, is 635 nm, the sensitive luminescent material more preferably has a maximum absorption wavelength of 600 to 650 nm.

<Hard Coating Layer>

A hard coating layer according to an aspect of the present invention includes a cured product of the sensitive luminescent composition of the present invention, and therefore improves the beam visibility of a laser pointer emitting light with a wavelength in a range of 450 to 700 nm is improved.

A method for applying the photosensitive luminescent composition may be any method used in the art without particular limitation, and examples of the methods may include dye coating, air knife coating, reverse roll coating, spray coating, blade coating, casting, gravure coating, micro gravure coating or spin coating.

According to an exemplary embodiment of the present invention, the above-described sensitive luminescent composition may further include one or more selected from the group consisting of a photopolymerizable compound, a photoinitiator, a solvent and an additive, and thus may be used in the formation of a hard coating layer.

According to an exemplary embodiment of the present invention, when the sensitive luminescent composition is used in the formation of a hard coating layer, the sensitive luminescent material may be included at 0.1 to 15 wt %, preferably, 1 to 10 wt %, and more preferably, 2 to 8 wt % with respect to 100 wt % of the entire sensitive luminescent composition for forming the hard coating layer, which includes the material. When the content of the sensitive luminescent material is less than the above-mentioned range, it may have less luminescence, and thus a laser pointer may have low visibility. However, when the content of the sensitive luminescent material is more than the above-mentioned range, it may be precipitated due to low compatibility, or may have low luminescence due to high-concentration quenching.

According to an exemplary embodiment of the present invention, when the sensitive luminescent composition of the present invention is used in the formation of a hard coating layer, the sensitive luminescent composition may further include scattering particles.

Scattering Particles

The sensitive luminescent composition according to an exemplary embodiment of the present invention may further include scattering particles.

When the scattering particles encounter emission light emitted from the sensitive luminescent material, an optical path becomes longer, and an emission intensity is increased, resulting in increased luminous efficiency.

The scattering particles may be any particles that are conventionally used in the art without particular limitation, and examples of the scattering particles may include organic microparticles such as silicone-based microparticles, melamine-based resin microparticles, acrylic resin microparticles (e.g., polymethylmethacrylate-based microparticles, etc.), acryl-styrene-based copolymer microparticles, polycarbonate-based microparticles, polystyrene-based microparticles, and benzoguanamine-based resin microparticles; and inorganic materials.

The organic microparticles may be spherical such that they can homogenize a scattering state of light, and here, the organic microparticles may have a diameter of 1 to 10 μm, and preferably 2 to 8 μm. When the diameter of the organic microparticles is in the above-mentioned range, an anti-glare property is increased.

The inorganic materials are not specifically limited, and preferably include a metal oxide.

The metal oxide may be an oxide including one or more selected from the group consisting of Li, Be, B, Na, Mg, Al, Si, K, Ca, Sc, V, Cr, Mn, Fe, Ni, Cu, Zn, Ga, Ge, Rb, Sr, Y, Mo, Cs, Ba, La, Hf, W, Tl, Pb, Ce, Pr, Nd, Pm, Sm, Eu, Gd, Tb, Dy, Ho, Er, Tm, Yb, Ti, Sb, Sn, Zr, Nb, Ce, Ta, In, and a combination thereof.

Specifically, the metal oxide may be one or more selected from the group consisting of Al₂O₃, SiO₂, ZnO, BaTiO₃, TiO₂, Ta₂O₅, ITO, IZO, ATO, ZnO—Al, Nb₂O₃, SnO, MgO and a combination thereof. When needed, a material which is surface-treated with a compound having an unsaturated bond such as an acrylate may also be used.

The inorganic materials may have an average particle diameter of 10 to 1000 nm, and more specifically, 100 to 500 nm. Here, when the particle diameter is less than the above-mentioned range, a sufficient scattering effect may not be expected from light emitted from the sensitive luminescent material, and when the particle diameter is more than the above-mentioned range, the inorganic material may be precipitated in the composition, or the surface of a hard coating layer, a photocurable adhesive layer, a heat-curable adhesive layer, a pressure-sensitive adhesive layer, or a base layer, which can be manufactured using the same, may not be smooth.

The scattering particles may be included at 1 to 10 wt %, preferably, 2 to 8 wt %, and more preferably, 3 to 7 wt % with respect to 100 wt % of the entire sensitive luminescent composition for forming a hard coating layer, which includes the particles. When the content of the scattering particles is less than the above-mentioned range, scattering performance may be insufficient, and when the content of the scattering particles is more than the above-mentioned range, a film may have low transmittance.

Photopolymerizable Compound

According to an exemplary embodiment of the present invention, the above-described sensitive luminescent composition may further include a photopolymerizable compound, which may include a (meth)acrylate oligomer and/or a monomer.

The (meth)acrylate oligomer may be epoxy(meth)acrylate or urethane(meth)acrylate, and preferably urethane(meth)acrylate.

The urethane(meth)acrylate may be used to prepare a compound including a multifunctional (meth)acrylate having a hydroxyl group in the molecule and a compound having an isocyanate group in the presence of a catalyst.

A specific example of the (meth)acrylate having a hydroxyl group in the molecule may be one or more selected from the group consisting of 2-hydroxyethyl methacrylate, 2-hydroxyisopropyl methacrylate, 4-hydroxybutyl methacrylate, caprolactone ring-opening hydroxyacrylate, a pentaerythritol tri/tetra(meth)acrylate mixture, and a dipentaerythritol penta/hexa(meth)acrylate mixture.

In addition, a specific example of the compound having an isocyanate group may be one or more selected from the group consisting of 1,4-diisocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexenediisocyanate, 4,4′-methylenebis(cyclohexylisocyanate), isophorone diisocyanate, toluene-2,4-diisocyanate, toluene-2,6-diisocyanate, xylene-1,4-diisocyanate, tetramethylxylene-1,3-diisocyanate, 1-chloromethyl-2,4-diisocyanate, 4,4′-methylenebis(2,6-dimethylphenylisocyanate), 4,4′-oxybis(phenylisocyanate), and tri-functional isocyanate derived from hexamethylenediisocyanate; and trimethane propanol adduct toluene diisocyanate.

The monomer may be any one used in the art, and a specific example of the monomer is a compound including a photopolymerizable functional group, for example, an unsaturated group such as a (meth)acryloyl group, a vinyl group, a styryl group, or an allyl group in the molecule, and preferably, a compound including a (meth)acryloyl group.

The monomer including a (meth)acryloyl group may be one or more selected from the group consisting of neopentyl glycol acrylate, 1,6-hexanediol (meth)acrylate, propylene glycol di(meth)acrylate, triethylene glycol di(meth)acrylate, dipropylene glycol di(meth)acrylate, polyethylene glycol di(meth)acrylate, polypropylene glycol di(meth)acrylate, trimethylolpropane tri(meth)acrylate, trimethylolethane tri(meth)acrylate, 1,2,4-cyclohexane tetra(meth)acrylate, pentaglycerol tri(meth)acrylate, pentaerythritol tetra(meth)acrylate, pentaerythritol tri(meth)acrylate, dipentaerythritol tri(meth)acrylate, dipentaerythritol penta(meth)acrylate, dipentaerythritol tetra(meth)acrylate, dipentaerythritol hexa(meth)acrylate, tripentaerythritol tri(meth)acrylate, tripentaerythritol hexatri(meth)acrylate, bis(2-hydroxyethyl)isocyanurate di(meth)acrylate, hydroxyethyl methacrylate, hydroxypropyl methacrylate, hydroxybutyl methacrylate, isooctyl methacrylate, iso-dexyl methacrylate, stearyl methacrylate, tetrahydroperfuryl methacrylate, phenoxyethyl methacrylate, and isoborneol(meth)acrylate.

The above-mentioned (meth)acrylate oligomers and/or monomers may be used alone or in combination of two or more thereof.

The above-described photopolymerizable compound may be included at 1 to 80 wt %, preferably, 5 to 70 wt %, and more preferably, 10 to 60 wt % with respect to 100 wt % of the entire sensitive luminescent composition for forming a hard coating layer, which includes the compound. When the content of the photopolymerizable compound is less than the above-mentioned range, hardness may be decreased, and when the content of the photopolymerizable compound is more than the above-mentioned range, severe curling may occur.

Photoinitiator

The sensitive luminescent composition according to an exemplary embodiment of the present invention may further include a photoinitiator.

The photoinitiator may be any initiator that is used in the art without particular limitation, and a specific example of the photoinitiator may be one or more selected from the group consisting of 2-methyl-1-[4-(methylthio)phenyl]2-morpholine propanone-1, diphenyl ketone, benzyl dimethyl ketal, 2-hydroxy-2-methyl-1-phenyl-1-one, 4-hydroxycyclophenyl ketone, dimethoxy-2-phenylacetophenone, anthraquinone, fluorene, triphenylamine, carbazole, 3-methylacetophenone, 4-chloroacetophenone, 4,4-dimethoxyacetophenone, 4,4-diaminobenzophenone, 1-hydroxy cyclohexyl phenyl ketone, and benzophenone.

The photoinitiator may be included at 0.1 to 20 wt %, and preferably, 0.5 to 10 wt % with respect to 100 wt % of the entire sensitive luminescent composition for forming a hard coating layer, which includes the initiator. When the content of the photoinitiator is less than the above-mentioned range, a curing rate may be reduced, and when the content of the photoinitiator is more than the above-mentioned range, a crack may be generated in the hard coating layer due to overcuring.

Solvent

The sensitive luminescent composition according to an exemplary embodiment of the present invention may further include a solvent.

The solvent may be any solvent that is used in the art without particular limitation, and specific examples of the solvents may include ethylene glycol monoalkyl ethers such as ethylene glycol monomethyl ether, ethylene glycol monoethyl ether, ethylene glycol monopropyl ether, ethylene glycol monobutyl ether, etc.; diethylene glycol dialkyl ethers such as diethylene glycol dimethyl ether, diethylene glycol diethyl ether, diethylene glycol dipropyl ether, diethylene glycol dibutyl ether, etc.; ethylene glycol alkyl ether acetates such as methyl cellosolve acetate, ethyl cellosolve acetate, etc.; alkylene glycol alkyl ether acetates such as propylene glycol monomethyl ether acetate, propylene glycol monoethyl ether acetate, propylene glycol monopropyl ether acetate, etc.; alkoxy alkyl acetates such as methoxy butyl acetate, methoxy pentyl acetate, etc.; aromatic hydrocarbons such as benzene, toluene, xylene, mesitylene, etc.; ketones such as methyl ethyl ketone, acetone, methyl amyl ketone, methylisobutylketone, cyclohexanone, etc.; alcohols such as ethanol, propanol, butanol, hexanol, cyclohexanol, ethyleneglycol, glycerin, etc.; esters such as ethyl 3-ethoxypropionate, methyl 3-methoxypropionate, etc.; and cyclic esters such as γ-butyrolactone, etc.

The solvent may be included at 10 to 95 wt %, preferably, 15 to 90 wt %, and more preferably, 20 to 80 wt % with respect to 100 wt % of the entire sensitive luminescent composition for forming a hard coating layer including the solvent. When the content of the solvent is less than the above-mentioned range, a viscosity of the composition including the solvent may be improved, thereby degrading workability, and when the content of the solvent is more than the above-mentioned range, a curing process takes too much time, thereby degrading economic feasibility.

Additive

The sensitive luminescent composition according to an exemplary embodiment of the present invention may further include an additive.

The additive may be selectively added as needed, and an example of the additive may be a different polymer compound, a curing agent, a leveling agent, an adhesion promoter, an antioxidant, a UV absorbent, or an anti-aggregation agent.

The different polymer compound may be, but is not limited to, specifically, a curable resin such as an epoxy resin or a maleimide resin, or a thermoplastic resin such as polyvinyl alcohol, polyacrylic acid, polyethylene glycol monoalkyl ether, polyfluoroalkyl acrylate, polyester, or polyurethane.

The curing agent may be used to improve deep-section curing and mechanical strength, and a specific example of the curing agent may be, but is not limited to, an epoxy compound, a multifunctional isocyanate compound, a melamine compound and an oxetane compound.

Regarding the curing agent, the epoxy compound may be, more specifically, a bisphenol A-based epoxy resin, a hydrogenated bisphenol A-based epoxy resin, a bisphenol F-based epoxy resin, a hydrogenated bisphenol F-based epoxy resin, a novolac-type epoxy resin, a different aromatic epoxy resin, an alicyclic epoxy resin, a glycidyl ester-based resin, a glycidyl amine-based resin, a brominated derivative of the epoxy resin, aliphatic, alicyclic or aromatic epoxy compound other than the epoxy resins and brominated derivatives thereof, a butadiene (co)polymer epoxide, an isoprene (co)polymer epoxide, a glycidyl methacrylate (co)polymer or triglycidyl isocyanurate.

Regarding the curing agent, the oxetane compound may be, more specifically, carbonate bisoxetane, xylene bisoxetane, adiphate bisoxetane, terephthalate bisoxetane or cyclohexane dicarboxylic acid bisoxetane.

The curing agent may be used in combination with a curing-aiding compound that can achieve ring-opening polymerization with an epoxy group of the epoxy compound or an oxetane backbone of the oxetane compound.

The curing-aiding compound may include, for example, polyhydric carboxylic acids, polyhydric carboxylic acid anhydrides, and acid generators. The polyhydric carboxylic acid anhydrides may be an epoxy resin curing agent which is commercially available. The commercially available product may be Adekahadona EH-700 (manufactured by Adeka Engineering Co., Ltd.), Likashitdo HH (manufactured by New Japan Chemicals Co., Ltd.) and MH-700 (manufactured by New Japan Chemicals Co., Ltd.). The above-mentioned curing agents and curing-aiding compounds may be used alone or in combination of two or more thereof.

As the leveling agent, a commercially available surfactant may be used to further improve the formation of a film of the composition, and a silicone-based, fluorine-based, ester-based, cationic, anionic, non-ionic or ampholytic surfactant may be used.

Examples of the commercially available silicone-based surfactants may be DC3PA, DC7PA, SH11PA, SH21PA and SH-8400 (manufactured by Dow Corning Toray Silicone Co., Ltd.), and TSF-4440, TSF-4300, TSF-4445, TSF-4446, TSF-4460 and TSF-4452 (manufactured by GE Toshiba Silicone Co., Ltd.).

Examples of the commercially available fluorine-based surfactants may be Megafac F-470, F-471, F-475, F-482 and F-489 (manufactured by Dainippon Ink and Chemicals Inc.).

In addition, other commercially available fluorine-based surfactants may include KP (Shin-Etsu Chemicals Co., Ltd.), POLYFLOW (Kyoei Yuji Chemicals Co., Ltd.), EFTOP (TOCHEM Products, Co., Ltd.), MEGAFAC (Dainippon Ink and Chemicals Co., Ltd.), Flourad (Sumitomo 3M Co, Ltd.), Asahi guard, Surflon (Asahi Glass Co., Ltd.), SOLSPERSE (Lubrisol), EFKA (EFKA Chemicals), PB 821 (Ajinomoto Co., Ltd.) and Disperbyk-series (BYK-chemi).

The cationic surfactant may be, for example, an amine salt such as stearylamine hydrochloride or lauryltrimethylammonium chloride, or a quaternary ammonium salt.

Examples of the anionic surfactants may include high alcohol ester sulfates such as sodium lauryl alcohol sulfate and sodium oleyl alcohol sulfate; alkyl sulfoxides such as sodium lauryl sulfate and ammonium lauryl sulfate; and alkyl aryl sulfonates such as sodium dodecyl benzene sulfonate and sodium dodecyl naphthalene sulfonate.

Examples of the non-ionic surfactants may include polyoxyethylene alkyl ether, polyoxyethylene aryl ether, polyoxyethylene alkyl aryl ether, other polyoxyethylene derivatives, an oxyethylene/oxypropylene block copolymer, sorbitan fatty acid ester, polyoxyethylene sorbitan fatty acid ester, polyoxyethylene sorbitol fatty acid ester, glycerin fatty acid ester, polyoxyethylene fatty acid ester and polyoxyethylene alkylamine.

The above-described surfactants may be used alone or in combination of two or more thereof.

A type of the adhesion promoter is not particularly limited, and specific examples of available adhesion promoters may include vinyl trimethoxysilane, vinyl triethoxysilane, vinyl tris(2-methoxyethoxy)silane, N-(2-aminoethyl)-3-aminopropylmethyl dimethoxysilane, N-(2-aminoethyl)-3-aminopropyl trimethoxysilane, 3-aminopropyl triethoxysilane, 3-glycidoxypropyl trimethoxysilane, 3-glycidoxypropylmethyl dimethoxysilane, 2-(3,4-epoxycyclohexyl)ethyl trimethoxysilane, 3-chloropropylmethyl dimethoxysilane, 3-chloropropyl trimethoxysilane, 3-methacryloxypropyl trimethoxysilane, 3-mercaptopropyl trimethoxysilane, 3-isocyanatepropyl trimethoxysilane, and 3-isocyanatepropyl triethoxysilane.

The adhesion promoter may be used alone or in combination of two or more thereof.

A type of the antioxidant may be, but is not particularly limited to, 2,2′-thiobis(4-methyl-6-t-butylphenol), or 2,6-di-t-butyl-4-methylphenol.

A type of the UV absorbent is not particularly limited, but specific examples of the available UV absorbents may include 2-(3-tert-butyl-2-hydroxy-5-methylphenyl)-5-chlorobenzotriazole, and alkoxybenzophenone.

A type of the anti-aggregation agent is not particularly limited, but an example of the available anti-aggregation agent may be sodium polyacrylate.

<Photocurable Adhesive Layer>

According to an exemplary embodiment of the present invention, the above-described sensitive luminescent composition may be used to form a photocurable adhesive layer, the photocurable adhesive layer may include a cured product of the sensitive luminescent composition of the present invention, and therefore the beam visibility of a laser pointer emitting light with a wavelength in a range of 450 to 700 nm may be improved.

A method for forming the photocurable adhesive layer may be any method used in the art without particular limitation, and for example, a method of dropping the sensitive luminescent composition for forming a photocurable adhesive layer of the present invention in a non-curable state between two bases to be adhered, uniformly spreading and pressing the composition using, for example, a roll, and then photocuring the adhesive to form an adhesive layer, but the present invention is not limited thereto.

A method of applying the sensitive luminescent composition for forming a photocurable adhesive layer may also be any method used in the art without particular limitation, and thus, for example, various methods such as methods using a doctor blade, a wire bar, a dye coater, a comma coater, a gravure coater, etc. may be used.

According to an exemplary embodiment of the present invention, the sensitive luminescent composition further includes one or more selected from the group consisting of a photopolymerizable compound, a photoinitiator, a solvent and an additive, and may be used to form a photocurable adhesive layer. Here, details on the photopolymerizable compound, the photoinitiator, the solvent and the additive may be the same as used in the formation of the hard coating layer, which is described above.

According to an exemplary embodiment of the present invention, when the sensitive luminescent composition is used to form a photocurable adhesive layer, the sensitive luminescent material may be included at 0.1 to 15 wt %, preferably, 1 to 10 wt %, and more preferably, 2 to 8 wt % with respect to 100 wt % of the entire sensitive luminescent composition for forming a photocurable adhesive layer, which includes the material. When the content of the sensitive luminescent material is less than the above-mentioned range, laser visibility is not sufficient due to low luminescence, and when the content of the sensitive luminescent material is more than the above-mentioned range, precipitation occurs due to low compatibility, or luminescence is decreased due to high concentration quenching.

<Heat-Curable Adhesive Layer>

According to an exemplary embodiment of the present invention, the above-described sensitive luminescent composition may be used to form a heat-curable adhesive layer, and as the heat-curable adhesive layer may include a cured product of the sensitive luminescent composition of the present invention, the visibility of a laser pointer emitting light with a wavelength in a range of 450 to 700 nm may be improved.

A method for forming the heat-curable adhesive layer may be any method generally used in the art without particular limitation, and may be the same as the method for forming the photocurable adhesive layer described above.

The sensitive luminescent composition according to an exemplary embodiment of the present invention may further include one or more selected from the group consisting of a heat-curable resin and a first crosslinking agent, and may be used as a sensitive luminescent composition for forming a heat-curable adhesive layer.

According to an exemplary embodiment of the present invention, when the sensitive luminescent composition is used to form a heat-curable adhesive layer, the sensitive luminescent material may be included at 0.1 to 15 wt %, preferably, 1 to 10 wt %, and more preferably, 2 to 8 wt % with respect to 100 wt % of the entire sensitive luminescent composition for forming a heat-curable adhesive layer, which includes the material. When the content of the sensitive luminescent material is less than the above-mentioned range, laser visibility is not sufficient due to low luminescence, and when the content of the sensitive luminescent material is more than the above-mentioned range, precipitation occurs due to low compatibility, or luminescence is decreased due to high concentration quenching.

Heat-Curable Resin

According to an exemplary embodiment of the present invention, the sensitive luminescent composition may further include a heat-curable resin.

The heat-curable resin may be any resin generally used in the art without particular limitation, and specifically, may be an isocyanate-based, polyvinyl alcohol-based, gelatin-based, vinylpolymer-based latex-type, or water-soluble polyester-based resin. In terms of affinity with a polarizer, a polyvinyl alcohol-based resin is preferably used.

The polyvinyl alcohol-based resin may be an acetoacetyl-modified, carboxyl-modified, methylol-modified, or amino-modified polyvinyl alcohol resin, and an acetoacetyl-modified polyvinyl alcohol-based resin is preferably used due to high reactivity and high durability.

The acetoacetyl-modified polyvinyl alcohol-based resin may be obtained by the reaction between a polyvinyl alcohol-based resin and diketene according to a known method. Specifically, the acetoacetyl-modified polyvinyl alcohol-based resin may be obtained by a method of adding diketene to a polyvinyl alcohol-based resin which has been dispersed in a solvent such as acetic acid, adding diketene to a polyvinyl alcohol-based resin which has been dissolved in a solvent such as dimethylformamide or dioxane, or directly contacting gaseous or liquid diketene with a polyvinyl alcohol-based resin. The acetoacetyl-modified polyvinyl alcohol-based resin may be any one that has an acetoacetyl-modification degree of 0.1 mol % or more without particular limitation, and the acetoacetyl-modification degree is preferably 0.1 to 40 mol %, more preferably, 1 to 20 mol %, and further more preferably, 2 to 7 mol %. When the acetoacetyl-modification degree is less than the above-mentioned range, the adhesive layer may have insufficient water resistance, and when the acetoacetyl-modification degree is more than the above-mentioned range, an effect of improving water resistance may be insignificant.

First Crosslinking Agent

According to an exemplary embodiment of the present invention, the sensitive luminescent composition may further include a first crosslinking agent.

The first crosslinking agent may be any resin generally used in the art without particular limitation, and to improve an adhesive strength, a glyoxylate is preferably used.

The glyoxylate may be an alkali metal salt or alkaline earth metal salt of glyoxylic acid and so on. Both of the alkali metal salt and alkaline earth metal salt of the glyoxylic acid exhibit almost the same effect, and there is no particular limitation on their use. It is presumed because both alkali metals and alkaline earth metals have low electronegativity, and a carboxylate of the metal or earth metal has similar chemical properties. In addition, a part of an acetoacetyl-modified polyvinyl alcohol acting as a crosslinking agent is an aldehyde group of the glyoxylate, and therefore it can be considered that the metal or earth metal will exhibit the same effect.

The glyoxylate may be an alkali metal salt of lithium glyoxylate, sodium glyoxylate, or potassium glyoxylate; or an alkaline earth metal salt of magnesium glyoxylate, calcium glyoxylate, strontium glyoxylate, or barium glyoxylate. Among these, in terms of solubility in water, an alkali metal salt is preferable, and sodium glyoxylate is more preferable.

The first crosslinking agent may be included at 3 to 25 wt %, preferably, 5 to 20 wt % with respect to 100 wt % of the entire sensitive luminescent composition for forming a heat-curable adhesive layer. When the content of the first crosslinking agent is in the above-mentioned range, water resistance may be improved, and the decrease in an optical characteristic such as transmittance or polarization degree may be prevented.

<Pressure-Sensitive Adhesive Layer>

According to an exemplary embodiment of the present invention, the sensitive luminescent composition may be used to form a pressure-sensitive adhesive layer, and as the pressure-sensitive adhesive layer includes a cured product of the sensitive luminescent composition of the present invention, the beam visibility of a laser pointer emitting light with a wavelength in a range of 450 to 700 nm may be improved.

A method for forming the pressure-sensitive adhesive layer may be any method generally used in the art without particular limitation.

The sensitive luminescent composition according to an exemplary embodiment of the present invention may be used as a sensitive luminescent composition for forming a pressure-sensitive adhesive layer by further including one or more selected from the group consisting of an acrylic copolymer and a second crosslinking agent.

According to an exemplary embodiment of the present invention, when the sensitive luminescent composition is used to form a pressure-sensitive adhesive layer, the sensitive luminescent material may be included at 0.1 to 15 wt %, preferably, 1 to 10 wt %, and more preferably, 2 to 8 wt % with respect to 100 wt % of the entire sensitive luminescent composition for a pressure-sensitive adhesive layer, which includes the material. When the content of the sensitive luminescent material is less than the above-mentioned range, laser visibility is insufficient due to low luminescence, and when the content of the sensitive luminescent material is more than the above-mentioned range, precipitation occurs due to low compatibility, or luminescence is decreased due to high concentration quenching.

Acrylic Copolymer

According to an exemplary embodiment of the present invention, the sensitive luminescent composition may further include an acrylic copolymer.

The acrylic copolymer is a pressure-sensitive adhesive resin, which is a copolymer of a (meth)acrylate monomer with an alkyl group having 1 to 12 carbon atoms and a monomer having a crosslinkable functional group. Here, the (meth)acrylate includes both an acrylate and a methacrylate.

The (meth)acrylate monomer with an alkyl group having 1 to 12 carbon atoms may be n-butyl methacrylate, 2-butyl methacrylate, t-butyl methacrylate, 2-ethylhexyl methacrylate, ethyl methacrylate, methyl methacrylate, methylethyl methacrylate, n-propyl methacrylate, isopropyl methacrylate, pentyl methacrylate, n-octyl methacrylate, isooctyl methacrylate, nonyl methacrylate, decyl methacrylate, or lauryl methacrylate, which may be used alone or in combination of two or more thereof.

Among these, n-butyl methacrylate, 2-ethylhexyl methacrylate or a mixture thereof is preferably used.

The (meth)acrylate monomer with an alkyl group having 1 to 12 carbon atoms may be included at 80 to 99 wt %, and preferably, 90 to 95 wt % with respect to 100 wt % of the total monomers used in preparation of the acrylic copolymer. When the content of the (meth)acrylate monomer with an alkyl group having 1 to 12 carbon atoms is less than 80 wt %, pressure-sensitive adhesive strength is insufficient, and when the content of the (meth)acrylate monomer with an alkyl group having 1 to 12 carbon atoms is more than 99 wt %, cohesive strength may be decreased.

The monomer having a crosslinkable functional group is a component that reinforces the cohesive strength or pressure-sensitive adhesive strength of a pressure-sensitive adhesive composition through chemical bonding to impart durability and breakability, and examples of the monomer having a crosslinkable functional group may include a monomer having a hydroxyl group, a monomer having a carboxyl group, a monomer having an amide group, and a monomer having a tertiary amine group, which may be used alone or in combination of two or more thereof.

The monomer having a hydroxyl group may be 2-hydroxyethyl methacrylate, 2-hydroxypropyl methacrylate, 2-hydroxybutyl methacrylate, 4-hydroxybutyl methacrylate, 6-hydroxyhexyl methacrylate, 2-hydroxyethyleneglycol (meth)acrylate, 2-hydroxypropyleneglycol (meth)acrylate, hydroxyalkyleneglycol (meth)acrylate with an alkylene group having 2 to 4 carbon atoms, 4-hydroxybutyl vinyl ether, 5-hydroxypentyl vinyl ether, 6-hydroxyhexyl vinyl ether, 7-hydroxyheptyl vinyl ether, 8-hydroxyoctyl vinyl ether, 9-hydroxynonyl vinyl ether, or 10-hydroxydecyl vinyl ether, and preferably 4-hydroxybutyl vinyl ether.

The monomer having a carboxyl group may be a monoprotic acid such as (meth)acrylic acid or crotonic acid; a biprotic acid such as maleic acid, itaconic acid or fumaric acid and a monoalkyl ester thereof; 3-(meth)acryloyl propionic acid; a succinic anhydride ring-opening adduct of 2-hydroxyalkyl methacrylate with an alkyl group having 2 to 3 carbon atoms, a succinic anhydride ring-opening adduct of hydroxyalkyleneglycol (meth)acrylate with an alkylene group having 2 to 4 carbon atoms, or a compound prepared through ring-opening addition of succinic anhydride to a caprolactone adduct of 2-hydroxyalkyl methacrylate with an alkyl group having 2 to 3 carbon atoms, and preferably (meth)acrylic acid.

The monomer having an amide group may be (meth)acrylamide, N-isopropylacrylamide, N-tertiary butylacrylamide, 3-hydroxypropyl(meth)acrylamide, 4-hydroxybutyl(meth)acrylamide, 6-hydroxyhexyl(meth)acrylamide, 8-hydroxyoctyl(meth)acrylamide, or 2-hydroxyethylhexyl(meth)acrylamide, and preferably (meth)acrylamide. The monomer having a tertiary amine group may be N,N-(dimethylamino)ethyl methacrylate, N,N-(diethylamino)ethyl methacrylate, or N,N-(dimethylamino)propyl methacrylate.

The monomer having a crosslinkable functional group may be included at 1 to 10 wt %, preferably, 1 to 8 wt % with respect to 100 wt % of the total monomers used in preparation of the acrylic copolymer. When the content of the monomer having a crosslinkable functional group is less than 1 wt %, durability may be decreased due to a low cohesive strength of a pressure-sensitive adhesive, and when the content of the monomer having a crosslinkable functional group is more than 10 wt %, the pressure-sensitive adhesive strength is decreased due to a high gel fraction, and thereby causing a durability issue.

In addition, a different polymerizable monomer other than the monomers may be further included at a content, for example, 10 wt % or less, which does not reduce the pressure-sensitive adhesive strength.

A method for preparing a copolymer is not particularly limited, and may be any method conventionally used in the art, for example, bulk polymerization, solution polymerization, emulsion polymerization or suspension polymerization, and preferably solution polymerization may be used. In addition, the method may use a solvent, a polymerization initiator, and a chain transfer agent for molecular weight control, which are generally used in polymerization.

The copolymer may have a weight average molecular weight (polystyrene conversion, Mw) of 50,000 to 2,000,000, or preferably, 40,000 to 2,000,000, as measured by gel permeation chromatography (GPC).

Second Crosslinking Agent

According to an exemplary embodiment of the present invention, the sensitive luminescent composition may further include a second crosslinking agent.

The second crosslinking agent may be the same component as the above-described first crosslinking agent, or a different component from the above-described first crosslinking agent.

The second crosslinking agent is a component for reinforcing the cohesive strength of an adhesive by suitably crosslinking the above-described acrylic copolymer, and a type of the second crosslinking agent is not particularly limited. For example, the second crosslinking agent may be an isocyanate-based compound, or an epoxy-based compound, which may be used alone or in combination of two or more thereof.

The isocyanate-based compound may be a diisocyanate compound such as tolylene diisocyanate, xylene diisocyanate, 2,4-diphenylmethane diisocyanate, 4,4-diphenylmethane diisocyanate, hexamethylene diisocyanate, isophorone diisocyanate, tetramethylxylene diisocyanate, or naphthalene diisocyanate; an adduct prepared by reacting 3 mol of a diisocyanate compound with 1 mol of a polyhydric alcohol-based compound, such as trimethylolpropane, a self-condensing isocyanurate body obtained from 3 mol of a diisocyanate compound, a burette body compound prepared by condensing the remaining 1 mol after obtaining diisocyanate urea from 2 mol among 3 mol of a diisocyanate compound, or a multifunctional isocyanate compound containing three functional groups such as triphenylmethane triisocyanate, methylenebis triisocyanate, etc.

The epoxy-based compound may be ethylene glycol diglycidyl ether, diethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, polytetramethylene glycol diglycidyl ether, glycerol diglycidyl ether, glycerol triglycidyl ether, diglycerol polyglycidyl ether, polyglycerol polyglycidyl ether, resorcine diglycidyl ether, 2,2-dibromoneopentyl glycol diglycidyl ether, trimethylolpropane triglycidyl ether, pentaerythritol polyglycidyl ether, sorbitol polyglycidyl ether, adipic acid diglycidyl ester, phthalic acid diglycidyl ester, tris(glycidyl)isocyanurate, tris(glycidoxyethyl)isocyanurate, 1,3-bis(N,N-glycidylaminomethyl)cyclohexane, or N,N,N′,N′-tetraglycidyl-m-xylenediamine etc.

In addition, the second crosslinking agent may further include a melamine-based compound as well as the isocyanate-based compound, and the epoxy-based compound, which may be used alone or in combination with two or more thereof.

The melamine-based compound may be hexamethylol melamine, hexamethoxymethyl melamine, or hexabutoxymethyl melamine.

The second crosslinking agent may be included at 0.1 to 15 parts by weight, and preferably, 0.1 to 5 parts by weight with respect to 100 parts by weight of the acrylic copolymer, on the basis of solid content. When the content of the second crosslinking agent is less than 0.1 part by weight, cohesive strength may be decreased due to an insufficient crosslinking degree, and therefore the degradation in durability such as lift-off may be caused, and breakability may be degraded, and when the content of the second crosslinking agent is more than 15 parts by weight, a problem in relaxation of residual stress due to overcrosslinking may be caused.

<Base Layer>

According to an exemplary embodiment of the present invention, the sensitive luminescent composition may be used to form a base layer of an optical film, which can improve the beam visibility of a laser pointer emitting light with a wavelength of 450 to 700 nm by including a cured product of the sensitive luminescent composition of the present invention.

According to an exemplary embodiment of the present invention, the sensitive luminescent composition may be used to form a base layer of an optical film by further including a base resin.

According to an exemplary embodiment of the present invention, when the sensitive luminescent composition is used to form a base layer, the sensitive luminescent material may be included at 0.1 to 15 wt %, preferably, 1 to 10 wt %, and more preferably, 2 to 8 wt % with respect to 100 wt % of the entire sensitive luminescent composition for forming a base layer, which includes the material. When the content of the sensitive luminescent material is less than the above-mentioned range, laser visibility may be insufficient due to low luminescence, and when the content of the sensitive luminescent material is more than the above-mentioned range, precipitation occurs due to low compatibility, or the luminescence is decreased due to high concentration quenching.

The base resin may be any resin that can form a transparent plastic film without particular limitation, and an example of the base resin may be a cycloolefin-based derivative having a unit of a cycloolefin-containing monomer such as norbornene or a polycyclic norbornene-based monomer, a cellulose selected from diacetyl cellulose, triacetyl cellulose, acetyl cellulose butylate, isobutyl ester cellulose, propionyl cellulose, butyryl cellulose and acetyl propionyl cellulose, an ethylene-acetic acid vinyl copolymer, polyester, polystyrene, polyamide, polyetherimide, polyacryl, polyimide, polyethersulfone, polysulfone, polyethylene, polypropylene, polymethylpentene, polyvinyl chloride, polyvinylidene chloride, polyvinyl alcohol, polyvinyl acetal, polyetherketone, a polyetheretherketone, polyethersulfone, polymethylmethacrylate, polyethylene terephthalate, polybutylene terephthalate, polyethylene naphthalate, polycarbonate, polyurethane, or an epoxy, or a non-stretched, uniaxially- or biaxially-stretched resin.

Preferably, the base resin is polyester having excellent transparency and thermal resistance, a cycloolefin-based derivative which has excellent transparency and thermal resistance and can cope with the formation of a large-sized film, or triacetyl cellulose due to transparency and no optical anisotropy.

<Image Display>

Still another aspect of the present invention provides an image display which improves the beam visibility of a laser pointer emitting light with a wavelength of 450 to 700 nm by including the above-described hard coating layer. In addition, the image display may include one or more selected from the group consisting of the photocurable adhesive layer, the heat-curable adhesive layer and the base layer, which can be formed of the sensitive luminescent composition of the present invention as described above.

The image display may be, for example, a liquid crystal display, an OLED, or a flexible display, but the present invention is not limited thereto.

Hereinafter, exemplary examples of the present invention will be provided to help in understanding of the present invention, but it should be apparent to those of ordinary skill in the art that the following examples are merely illustrative of the present invention, and various changes and modifications within the scope and spirit of the present invention can be made and included within the scope of the accompanying claims. In the following Examples and Comparative Examples, the “%” and “part” representing content are based on weight unless particularly defined otherwise.

### Examples 1 to 8 and Comparative Examples 1 to 3: Preparation of Sensitive Luminescent Composition for Forming Hard Coating Layer

### Example 1

A sensitive luminescent composition for forming a hard coating layer was prepared by mixing 5 parts by weight of Lumogen F Pink 285 (BASF SE) as a sensitive luminescent material, 25 parts by weight of urethane acrylate (MU9500; Miwon Specialty Chemical Co., Ltd.) and 25 parts by weight of pentaerythritol triacrylate (M340; Miwon Specialty Chemical Co., Ltd.) as photopolymerizable compounds, 2.5 parts by weight of 1-184 (Ciba Specialty Chemicals, Inc.) as a photoinitiator, 15 parts by weight of methyl ethyl ketone (Daejung Chemicals & Metals Co., Ltd.) and 27 parts by weight of propylene glycol monomethyl ether (Daejung Chemicals & Metals Co., Ltd.) as solvents, and 0.5 part by weight of a leveling agent (BYK3570, BYK Chemicals) as an additive using an agitator, and filtering the resulting mixture using a filter of a polypropylene (PP) material.

### Example 2

A sensitive luminescent composition for forming a hard coating layer was prepared by mixing 5 parts by weight of Lumogen F Orange 240 (BASF SE) as a sensitive luminescent material, 25 parts by weight of urethane acrylate (MU9500; Miwon Specialty Chemical Co., Ltd.) and 25 parts by weight of pentaerythritol triacrylate (M340; Miwon Specialty Chemical Co., Ltd.) as photopolymerizable compounds, 2.5 parts by weight of 1-184 (Ciba Specialty Chemicals, Inc.) as a photoinitiator, 15 parts by weight of methyl ethyl ketone (Daejung Chemicals & Metals Co., Ltd.) and 27 parts by weight of propylene glycol monomethyl ether (Daejung Chemicals & Metals Co., Ltd.) as solvents, and 0.5 part by weight of a leveling agent (BYK3570, BYK Chemicals) as an additive using an agitator, and filtering the resulting mixture using a filter of a polypropylene (PP) material.

### Example 3

A sensitive luminescent composition for forming a hard coating layer was prepared by mixing 5 parts by weight of Lumogen F Red 305 (BASF SE) as a sensitive luminescent material, 25 parts by weight of urethane acrylate (MU9500; Miwon Specialty Chemical Co., Ltd.) and 25 parts by weight of pentaerythritol triacrylate (M340; Miwon Specialty Chemical Co., Ltd.) as photopolymerizable compounds, 2.5 parts by weight of 1-184 (Ciba Specialty Chemicals, Inc.) as a photoinitiator, 15 parts by weight of methyl ethyl ketone (Daejung Chemicals & Metals Co., Ltd.) and 27 parts by weight of propylene glycol monomethyl ether (Daejung Chemicals & Metals Co., Ltd.) as solvents, and 0.5 part by weight of a leveling agent (BYK3570, BYK Chemicals) as an additive using an agitator, and filtering the resulting mixture using a filter of a polypropylene (PP) material.

### Example 4

A sensitive luminescent composition for forming a hard coating layer was prepared by mixing 5 parts by weight of Lumogen F Pink 285 (BASF SE) as a sensitive luminescent material, 2 parts by weight of silicone particles (4.5 μm, Momentive Performance Materials Inc.) as scattering particles, 25 parts by weight of urethane acrylate (MU9500; Miwon Specialty Chemical Co., Ltd.) and 25 parts by weight of pentaerythritol triacrylate (M340; Miwon Specialty Chemical Co., Ltd.) as photopolymerizable compounds, 2.5 parts by weight of 1-184 (Ciba Specialty Chemicals, Inc.) as a photoinitiator, 15 parts by weight of methyl ethyl ketone (Daejung Chemicals & Metals Co., Ltd.) and 27 parts by weight of propylene glycol monomethyl ether (Daejung Chemicals & Metals Co., Ltd.) as solvents, and 0.5 part by weight of a leveling agent (BYK3570, BYK Chemicals) as an additive using an agitator, and filtering the resulting mixture using a filter of a polypropylene (PP) material.

### Example 5

A sensitive luminescent composition for forming a hard coating layer was prepared by mixing 5 parts by weight of Alexa Fluor 633 (Thermo Fisher Scientific Inc.) as a sensitive luminescent material, 25 parts by weight of urethane acrylate (MU9500; Miwon Specialty Chemical Co., Ltd.) and 25 parts by weight of pentaerythritol triacrylate (M340; Miwon Specialty Chemical Co., Ltd.) as photopolymerizable compounds, 2.5 parts by weight of 1-184 (Ciba Specialty Chemicals, Inc.) as a photoinitiator, 15 parts by weight of methyl ethyl ketone (Daejung Chemicals & Metals Co., Ltd.) and 27 parts by weight of propylene glycol monomethyl ether (Daejung Chemicals & Metals Co., Ltd.) as solvents, and 0.5 part by weight of a leveling agent (BYK3570, BYK Chemicals) as an additive using an agitator, and filtering the resulting mixture using a filter of a polypropylene (PP) material.

### Example 6

A sensitive luminescent composition for forming a hard coating layer was prepared by mixing 5 parts by weight of SureLight APC (Colombia Biosciences) as a sensitive luminescent material, 25 parts by weight of urethane acrylate (MU9500; Miwon Specialty Chemical Co., Ltd.) and 25 parts by weight of pentaerythritol triacrylate (M340; Miwon Specialty Chemical Co., Ltd.) as photopolymerizable compounds, 2.5 parts by weight of 1-184 (Ciba Specialty Chemicals, Inc.) as a photoinitiator, 15 parts by weight of methyl ethyl ketone (Daejung Chemicals & Metals Co., Ltd.) and 27 parts by weight of propylene glycol monomethyl ether (Daejung Chemicals & Metals Co., Ltd.) as solvents, and 0.5 part by weight of a leveling agent (BYK3570, BYK Chemicals) as an additive using an agitator, and filtering the resulting mixture using a filter of a polypropylene (PP) material.

### Example 7

A sensitive luminescent composition for forming a hard coating layer was prepared by mixing 5 parts by weight of allophycocyanin (Sigma-Aldrich) as a sensitive luminescent material, 25 parts by weight of urethane acrylate (MU9500; Miwon Specialty Chemical Co., Ltd.) and 25 parts by weight of pentaerythritol triacrylate (M340; Miwon Specialty Chemical Co., Ltd.) as photopolymerizable compounds, 2.5 parts by weight of 1-184 (Ciba Specialty Chemicals, Inc.) as a photoinitiator, 15 parts by weight of methyl ethyl ketone (Daejung Chemicals & Metals Co., Ltd.) and 27 parts by weight of propylene glycol monomethyl ether (Daejung Chemicals & Metals Co., Ltd.) as solvents, and 0.5 part by weight of a leveling agent (BYK3570, BYK Chemicals) as an additive using an agitator, and filtering the resulting mixture using a filter of a polypropylene (PP) material.

### Example 8

A sensitive luminescent composition for forming a hard coating layer was prepared by mixing 5 parts by weight of Alexa Fluor 633 (Thermo Fisher Scientific Inc.) as a sensitive luminescent material, 2 parts by weight of silicone particles (4.5 Momentive Performance Materials Inc.) as scattering particles, 25 parts by weight of urethane acrylate (MU9500; Miwon Specialty Chemical Co., Ltd.) and 25 parts by weight of pentaerythritol triacrylate (M340; Miwon Specialty Chemical Co., Ltd.) as photopolymerizable compounds, 2.5 parts by weight of 1-184 (Ciba Specialty Chemicals, Inc.) as a photoinitiator, 15 parts by weight of methyl ethyl ketone (Daejung Chemicals & Metals Co., Ltd.) and 27 parts by weight of propylene glycol monomethyl ether (Daejung Chemicals & Metals Co., Ltd.) as solvents, and 0.5 part by weight of a leveling agent (BYK3570, BYK Chemicals) as an additive using an agitator, and filtering the resulting mixture using a filter of a polypropylene (PP) material.

### Comparative Example 1

A sensitive luminescent composition for forming a hard coating layer was prepared by mixing 25 parts by weight of urethane acrylate (MU9500; Miwon Specialty Chemical Co., Ltd.) and 25 parts by weight of pentaerythritol triacrylate (M340; Miwon Specialty Chemical Co., Ltd.) as photopolymerizable compounds, 2.5 parts by weight of 1-184 (Ciba Specialty Chemicals, Inc.) as a photoinitiator, 20 parts by weight of methyl ethyl ketone (Daejung Chemicals & Metals Co., Ltd.) and 27 parts by weight of propylene glycol monomethyl ether (Daejung Chemicals & Metals Co., Ltd.) as solvents, and 0.5 part by weight of a leveling agent (BYK3570, BYK Chemicals) as an additive using an agitator, and filtering the resulting mixture using a filter of a polypropylene (PP) material.

### Comparative Example 2

A sensitive luminescent composition for forming a hard coating layer was prepared by mixing 5 parts by weight of Lumogen F Blue 650 (BASF SE) as a sensitive luminescent material, 25 parts by weight of urethane acrylate (MU9500; Miwon Specialty Chemical Co., Ltd.) and 25 parts by weight of pentaerythritol triacrylate (M340; Miwon Specialty Chemical Co., Ltd.) as photopolymerizable compounds, 2.5 parts by weight of 1-184 (Ciba Specialty Chemicals, Inc.) as a photoinitiator, 15 parts by weight of methyl ethyl ketone (Daejung Chemicals & Metals Co., Ltd.) and 27 parts by weight of propylene glycol monomethyl ether (Daejung Chemicals & Metals Co., Ltd.) as solvents, and 0.5 part by weight of a leveling agent (BYK3570, BYK Chemicals) as an additive using an agitator, and filtering the resulting mixture using a filter of a polypropylene (PP) material.

### Comparative Example 3

A sensitive luminescent composition for forming a hard coating layer was prepared by mixing 2 parts by weight of silicone particles (4.5 Momentive Performance Materials Inc.) as scattering particles, 25 parts by weight of urethane acrylate (MU9500; Miwon Specialty Chemical Co., Ltd.) and 25 parts by weight of pentaerythritol triacrylate (M340; Miwon Specialty Chemical Co., Ltd.) as photopolymerizable compounds, 2.5 parts by weight of 1-184 (Ciba Specialty Chemicals, Inc.) as a photoinitiator, 18 parts by weight of methyl ethyl ketone (Daejung Chemicals & Metals Co., Ltd.) and 27 parts by weight of propylene glycol monomethyl ether (Daejung Chemicals & Metals Co., Ltd.) as solvents, and 0.5 part by weight of a leveling agent (BYK3570, BYK Chemicals) as an additive using an agitator, and filtering the resulting mixture using a filter of a polypropylene (PP) material.

### Preparation Examples: Formation of Hard Coating Film

### Preparation Example 1

The sensitive luminescent composition for forming a hard coating layer of Example 1 was applied on a 40 μm triacetyl cellulose film so as to have a dry film thickness of 5 and then a solvent was dried for 2 minutes at 80° C. The dried film was irradiated with a UV at an integrated light intensity of 400 mJ/cm², resulting in the formation of a hard coating film.

### Preparation Example 2

A hard coating film was formed by the same method as described in Preparation Example 1, except that the sensitive luminescent composition for forming a hard coating layer of Example 2 was used.

### Preparation Example 3

A hard coating film was formed by the same method as described in Preparation Example 1, except that the sensitive luminescent composition for forming a hard coating layer of Example 3 was used.

### Preparation Example 4

A hard coating film was formed by the same method as described in Preparation Example 1, except that the sensitive luminescent composition for forming a hard coating layer of Example 4 was used, and applied on a triacetyl cellulose film so as to have a dry film thickness of 4 μm.

### Preparation Example 5

A hard coating film was formed by the same method as described in Preparation Example 1, except that the sensitive luminescent composition for forming a hard coating layer of Example 5 was used.

### Preparation Example 6

A hard coating film was formed by the same method as described in Preparation Example 1, except that the sensitive luminescent composition for forming a hard coating layer of Example 6 was used.

### Preparation Example 7

A hard coating film was formed by the same method as described in Preparation Example 1, except that the sensitive luminescent composition for forming a hard coating layer of Example 7 was used.

### Preparation Example 8

A hard coating film was formed by the same method as described in Preparation Example 4, except that the sensitive luminescent composition for forming a hard coating layer of Example 8 was used.

### Preparation Example 9

A hard coating film was formed by the same method as described in Preparation Example 1, except that the sensitive luminescent composition for forming a hard coating layer of Comparative Example 1 was used.

### Preparation Example 10

A hard coating film was formed by the same method as described in Preparation Example 1, except that the sensitive luminescent composition for forming a hard coating layer of Comparative Example 2 was used.

### Preparation Example 11

A hard coating film was formed by the same method as described in Preparation Example 4, except that the sensitive luminescent composition for forming a hard coating layer of Comparative Example 3 was used.

### Experimental Example 1: Measurement of Maximum Absorption Wavelength of Sensitive Luminescent Material

The maximum absorption wavelengths of the sensitive luminescent materials used in the examples and the comparative examples were measured using UV-Vis. (UV-2450, Shimadzu Scientific Instruments), and the result is shown in Table 1 below.

### Experimental Example 2: Confirmation of Visibility of Green Laser

Each of the hard coating films formed in Preparation Examples 1 to 4 and Preparation Examples 9 to 11 was adhered to the surface of an image display using a pressure-sensitive adhesive, and a laser point was formed on the surface of the corresponding hard coating film using a green laser pointer (532 nm) while a screen of the image display was turned on to be white. Here, the beam visibility of the laser pointer was identified in the front direction (in the direction of a normal line) by emitting light using the laser pointer at 45 degrees with respect to the normal line of the film, and evaluated according to the following evaluation criteria. The result is shown in Table 1 below.

<Evaluation Criteria>

5: A beam emitted from the laser pointer is larger and more clearly shown than an original laser beam.

4: A beam emitted from the laser pointer is clearly shown in a size of an original laser beam.

3: A beam emitted from the laser pointer is easily identified at a position pointed out by a laser pointer.

2: A position at which the laser point directed can be distinguished, but is not clearly shown due to low brightness.

1: A beam emitted from the laser pointer is not visible.

### Experimental Example 3: Identification of Visibility of Red Laser

Each of the hard coating films formed in Preparation Examples 5 to 8 and Preparation Examples 9 to 11 was adhered to the surface of an image display using a pressure-sensitive adhesive, and a laser point was formed on the surface of the corresponding hard coating film using a red laser pointer (635 nm) while a screen of the image display was turned on to be white. Here, the beam visibility of the laser pointer was identified in the front direction (in the direction of a normal line) by emitting light using the laser pointer at 45 degrees with respect to the normal line of the film, and evaluated according to the following evaluation criteria. The result is shown in Table 1 below.

<Evaluation Criteria>

5: A beam emitted from the laser pointer is larger and more clearly shown than an original laser beam.

4: A beam emitted from the laser pointer is clearly shown in a size of an original laser beam.

3: A beam emitted from the laser pointer is more easily identified at a position pointed out by a laser pointer.

2: A position at which the laser point directed can be distinguished, but is not clearly shown due to low brightness.

1: A Beam Emitted from the Laser Pointer is not Visible.

### Experimental Example 3: Measurement of Pencil Hardness

Each of the hard coating films formed in Preparation Examples 1 to 11 was fixed on glass so that a coated surface faced upward, and a hardness, when a load of 1 kg was applied, was measured. Five experiments were repeatedly performed on each hard coating film, and a value of hardness secured four or more times was recorded as a pencil hardness of the coating film, and the result is shown in Table 1 below.

### Experimental Example 4: Evaluation of Scratch Resistance

Each of the hard coating films formed in Preparation Examples 1 to 11 was fixed on a glass so that a coated surface faced upward, ten back-and-forth scratch tests were conducted using steel wool (#0000) under the condition of a load of 250 g/cm². Evaluation criteria are as follows, and the result is shown in Table 1 below.

<Evaluation criteria>

∘: 10 or less scratches

Δ: more than 10 to 20 or less scratches

x: more than 20 scratches

### Experimental Example 5: Adhesion Test

Each of the hard coating films formed in Preparation Examples 1 to 11 was fixed on a glass so that a coated surface faced upward, 11 vertical and horizontal straight lines were scored in a coated surface using a cutter knife at 1-mm intervals to make 100 squares, and then a peel test was carried out using tape (Nichiban CT-24). Adhesion was evaluated by the following Mathematical Formula 1, and the result is shown in Table 1 below.

Adhesion=n/100 [Mathematical Formula 1]

(In Mathematical Formula 1, n represents the number of unpeeled squares.)

TABLE 1

| | | Maximum | | | | | |
|---|---|---|---|---|---|---|---|
| Sensitive | Hard | absorption | Visibility | | | | |
| luminescent | coating | wavelength | of green | Visibility | Pencil | Scratch | |
| composition | film | (nm) | laser | of red laser | hardness | resistance | Adhesion |
| Example 1 | Preparation | 547 | 4 | — | 3H | ∘ | 100/100 |
| | Example 1 | | | | | | |
| Example 2 | Preparation | 524 | 4 | — | 3H | ∘ | 100/100 |
| | Example 2 | | | | | | |
| Example 3 | Preparation | 578 | 4 | — | 3H | ∘ | 100/100 |
| | Example 3 | | | | | | |
| Example 4 | Preparation | 547 | 5 | — | 3H | ∘ | 100/100 |
| | Example 4 | | | | | | |
| Example 5 | Preparation | 632 | — | 4 | 3H | ∘ | 100/100 |
| | Example 5 | | | | | | |
| Example 6 | Preparation | 652 | — | 4 | 3H | ∘ | 100/100 |
| | Example 6 | | | | | | |
| Example 7 | Preparation | 650 | — | 4 | 3H | ∘ | 100/100 |
| | Example 7 | | | | | | |
| Example 8 | Preparation | 632 | — | 5 | 3H | ∘ | 100/100 |
| | Example 8 | | | | | | |
| Comparative | Preparation | — | 1 | 1 | 3H | ∘ | 100/100 |
| Example 1 | Example 9 | | | | | | |
| Comparative | Preparation | 377 | 2 | 2 | 3H | ∘ | 100/100 |
| Example 2 | Example 10 | | | | | | |
| Comparative | Preparation | — | 2 | 2 | 3H | ∘ | 100/100 |
| Example 3 | Example 11 | | | | | | |

Referring to Table 1, it can be confirmed that the hard coating films (Preparation Examples 1 to 8) formed using the compositions (Examples 1 to 8) for forming a hard coating layer, including the sensitive luminescent composition of the present invention, compared to the hard coating films (Preparation Examples 9 to 11) formed using the compositions (Comparative Examples 1 to 3) for forming a hard coating layer, not including the sensitive luminescent composition of the present invention, had no differences in pencil hardness, scratch resistance and adhesion, higher laser visibility, and higher beam visibility of a laser pointer.

Specifically, it can be confirmed that the compositions (Examples 1 to 4) for forming a hard coating layer, including the sensitive luminescent material having an absorption wavelength range of 450 to 600 nm, had higher visibility with respect to a green laser than the cases (Comparative Examples 1 and 3) without a sensitive luminescent composition and the case (Comparative Example 2) having a range beyond the maximum absorption wavelength range presented in the present invention.

In addition, it can be confirmed that the compositions (Examples 5 to 8) for forming a hard coating layer, including a sensitive luminescent material having an absorption wavelength range of 600 to 700 nm, had higher visibility with respect to a red laser than the cases (Comparative Examples 1 and 3) without a sensitive luminescent composition and the case (Comparative Example 2) having a range beyond the maximum absorption wavelength range presented in the present invention.

Particularly, it can be confirmed that the hard coating films (Preparation Examples 4 and 8) formed using the compositions (Examples 4 and 8) for forming a hard coating layer, including a sensitive luminescent composition and further including scattering particles, had higher laser visibility than the hard coating films (Preparation Examples 1 to 3 and Preparation Examples 5 to 7) formed using the compositions (Examples 1 to 3 and Examples 5 to 7) for forming a hard coating layer, including a sensitive luminescent composition without scattering particles.

1. A sensitive luminescent composition, comprising:
a sensitive luminescent material having a maximum absorption wavelength of 450 to 700 nm.

2. The composition of claim 1, wherein the sensitive luminescent material includes a sensitive luminescent material having a maximum absorption wavelength of 450 to 600 nm.

3. The composition of claim 1, wherein the sensitive luminescent material includes a sensitive luminescent material having a maximum absorption wavelength of 600 to 700 nm.

4. The composition of claim 1, further comprising:
one or more selected from the group consisting of a photopolymerizable compound, a photoinitiator, a solvent and an additive.

5. The composition of claim 4, which is used to form a hard coating layer.

6. The composition of claim 5, further comprising: scattering particles.

7. The composition of claim 5, wherein the sensitive luminescent material is included at 0.1 to 15 wt % with respect to 100 wt % of the entire sensitive luminescent composition for forming a hard coating layer, including the material.

8. The composition of claim 4, which is used to form a photocurable adhesive layer.

9. The composition of claim 8, wherein the sensitive luminescent material is included at 0.1 to 15 wt % with respect to 100 wt % of the entire sensitive luminescent composition for forming a photocurable adhesive layer, including the material.

10. The composition of claim 1, further comprising:
one or more selected from the group consisting of a heat-curable resin and a first crosslinking agent, and
the composition is used to form a heat-curable adhesive layer.

11. The composition of claim 10, wherein the sensitive luminescent material is included at 0.1 to 15 wt % with respect to 100 wt % of the entire sensitive luminescent composition for forming a heat-curable adhesive layer, including the material.

12. The composition of claim 1, wherein the sensitive luminescent material further comprises one or more selected from the group consisting of an acrylic copolymer and a second crosslinking agent, and the composition is used to form a pressure-sensitive adhesive layer.

13. The composition of claim 1, further comprising:
a base resin, and
the composition is used to form a base of an optical film.

14. A hard coating layer, comprising a cured product of the sensitive luminescent composition of claim 5.

15. An image display, comprising a cured product of the sensitive luminescent composition of claim 1.
